(19) United States
(12) Patent Application Publication
(10) Pub. No.: US 2004/0111471 A1
(43) Pub. Date: Jun. 10, 2004

(54) Alarm monitoring system for a telecommunications network

(75) Inventors: Robert Stoner, Colorado Springs, CO (US); Matthew Griego, Monument, CO (US); Glen Manas, Hanscom AFB, MA (US)

Correspondence Address: WORLDCOM, INC., TECHNOLOGY LAW DEPARTMENT, 1133 19TH STREET NW, WASHINGTON, DC, 20036, US

(73) Assignee: WorldCom, Inc., Ashburn, VA

(21) Appl. No.: 10/725,505

(22) Filed: Dec. 3, 2003

Related U.S. Application Data
(63) Continuation of application No. 09/300,063, filed on Apr. 27, 1999.

(51) Int. Cl. G06F 15/16

(52) U.S. Cl. 709/204

(57) ABSTRACT

A Network Alarm Monitoring System for monitoring messages generated by network elements that provides for a great degree of configuration and reliability. Via a display interface, e.g., Web-based or otherwise, clients may create and configure text-based rules for monitoring alarms. These rules are applied to specify which actions are to be taken on which messages, based on designated field values of alarm messages. Actions include writing messages to an alarm database, sending messages to downstream network management systems, triggering an e-mail or page. Furthermore, remote access to the network element being monitored is provided.

### FIELD OF THE INVENTION

The present invention relates generally to telecommunications networks, and particularly, to a novel, robust alarm monitoring system for telecommunications networks.

### BACKGROUND OF THE INVENTION

Most telecommunications networks today employ some type of service computing platform designed to handle real-time call processing services. Typically, these platforms are known as Service Control Points (“SCPs”) and are distinct from, and most often, remotely located from the network switches where a call arrives. In the telecommunications networks owned and operated by the assignee of the instant invention, a service control point is referred to as a Data Access Point (“DAP”). FIG. 1 illustrates the physical architecture of a DAP employed in a switched network architecture owned and operated by the assignee of the instant invention. Typically, three redundant DAPs 10 are employed, one of which is depicted in FIG. 1. Additionally, there are provided one or more network switches 15, each of which is connected to each DAP via two redundant X.25 protocol communications links 17 over an X.25 network. The DAP 10 shown in FIG. 1 comprises many computers that are each connected to a Fiber Distributed Data Interface (FDDI) ring 23, which provides data communications among the DAP computers.

Additionally, as shown in FIG. 1, there are typically a plurality of communications servers 20 that each receive service request messages from switches 15 in the network. When a switch receives a call that requires enhanced call processing, it sends a service request message to one of the three DAPs 10. Each switch round-robins its service request messages to the three DAPs, so that each DAP can be used by each switch over a brief period of time. The Communication Server manages communications over the X.25 network 20, strips out the X.25 protocol, and forwards the service request message to one of a plurality of Transaction Servers, depicted in the FIG. 1 as Transaction Servers 25a, . . . , 25f. Transaction Servers are clustered per service into redundant pairs with corresponding shared disk arrays. In the example architecture shown in FIG. 1, there is a Transaction Server cluster 25a, 25b for Virtual Private Network (VPN) services having a shared disk array 26, a Transaction Server cluster 25c, 25d for Special Area Code (e.g., 800) and Calling Card Services having a shared disk array 27, and a Transaction Server cluster 25e, 25f for international and Local Number Portability (LNP) services having a shared disk array 28. The Transaction Server that receives the service request message, processes the message and returns a service response message which the Communication Server 20 forwards to the switch.

Additionally employed within the system is a Service Control Manager (“SCM”) 21 that functions to provision the DAP 10 with data and applications that are provided in mainframe order entry systems. The SCM 21 interfaces with the DAP 10 via a Communication Server 22 using an X.25 link 18, as do the switches. Collectively, the three DAPs and the SCM are known as a Network Control System (“NCS”) 11.

Since SCPs (and DAPs) are used for real-time call processing, their operation and health are considered extremely critical to the operator of the network. Thus, it is important that a network operator be able to monitor messages that are constantly being generated by both the operating systems and the call processing applications running on these computing platforms. Current network alarm monitoring systems are provided with the processes for monitoring each Transaction Server and Communication Server in the network, as well as the SCM, which is generally done by calling all of the messages generated by the operating systems and call processing applications that run on each of these computers, identifying those messages indicative of a negatively impacting event, and reporting these messages to a network management system or personnel. Currently, such monitoring systems are embedded in the source code running these applications and typically implement static logic for monitoring alarm conditions.

It is the case that, in a typical network, there are many different types of messages being generated by the numerous call-processing applications. As the logic used to monitor alarms tends to be static and embedded in source code, current alarm monitoring systems are not easily configurable, preventing a user from easily specifying which types of messages should be designated as alarms, and which actions should be taken on each type of message. One prior network computing product, e.g., the Virtual Console System (VCS) system (available from Digital Equipment Corp.) provides a Virtual Memory System (VMS) operating system architecture. However, commercially available products for network alarm monitoring are not designed to run on DEC VMS systems.

Furthermore, it would be useful for such systems to be open and portable to different platforms. As prior systems are largely based on proprietary technology, current network alarm monitoring systems are limited in their portability and configurability.

### SUMMARY OF THE INVENTION

The present invention is a NCS Alarm Monitoring System (“NAMS”) that provides a greater degree of configuration and reliability than prior art systems. Via a simple text editor or a Web-based user interface, clients can monitor, log onto systems, create and configure text-based rules for monitoring alarms. These rules, when applied by NAMS, specify which actions are to be taken on which messages, based on designated field values of alarm messages. Examples of actions include writing messages to an alarm database, sending messages to downstream network management systems, triggering an e-mail or page to operational support staff.

In a preferred aspect of the invention, a NAMS server asynchronously receives a continuous stream of messages generated by two sources: 1) console connections; and 2) application connections using either TCP/IP or DECNet™ Protocols that execute on the NCS computing platforms. Data delivered via console connections using telnet protocols are not structured and accordingly are mapped to a “higher” order alarm structure provided by a function executed in the NAMS server according to the principles of the invention. Using regular expression matching techniques, the alarm messages from each source are identified and user-defined rules are applied to specify appropriate action to be taken on each message, based on the contents of each message. A user interface is provided in the form of a Java™ applet or application, for example, to enable a user to easily define these rules, and as a result, specify which types of messages they want to be considered as alarms.

Advantageously, NAMS may be designed to take advantage of clustering for increased reliability. Moreover, NAMS is based in open non-proprietary technology, in the form of Web-based interfaces, ASCII text messages, and ASCII text rules to enable portability.

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

### BRIEF DESCRIPTION OF DRAWINGS

FIG. 1 illustrates the physical architecture of a prior art SCP implemented in a telecommunications network.

FIG. 2 illustrates the network alarm monitoring system architecture of the present invention.

FIG. 3 illustrates conceptually the NAMS connectivity to the systems being monitored.

FIG. 4 is a data flow diagram illustrating the NAMS system architecture of the invention.

FIG. 5 is a flow chart depicting the alarm processing performed by the NAMS server.

FIG. 6(a) illustrates the architecture for presenting alarm information to a user via a remote socket connection.

FIG. 6(b) illustrates the architecture for presenting alarm information to a user with a GUI application downloaded via a Web server to a user platform.

FIG. 7 illustrates an exemplary screen display presenting real-time alarm information to a user in accordance with the AMTS application.

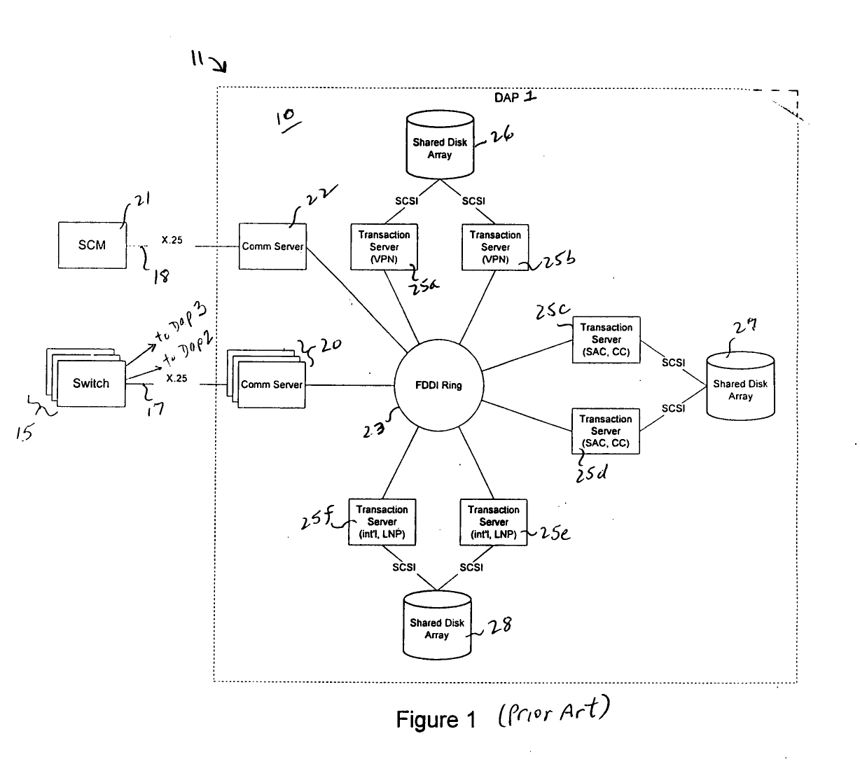

### DETAILED DESCRIPTION OF THE INVENTION

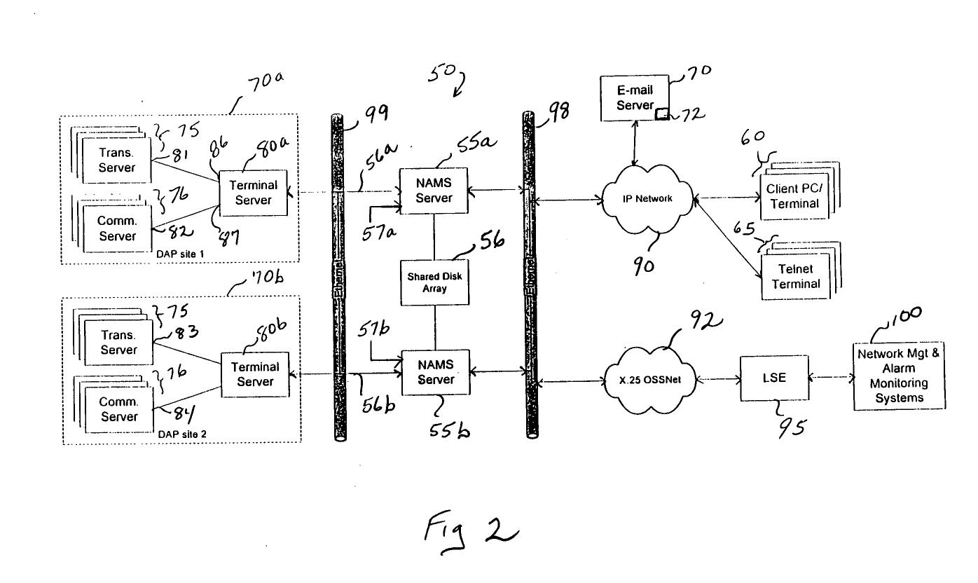

FIG. 2 illustrates the physical architecture of the NCS Alarm Monitoring System (“NAMS”) 50 of the present invention. As shown, the NAMS 50 comprises a NAMS server 55a, with a second NAMS server 55b provided for redundancy, reliability and performance. Each NAMS server 55a,b is a general purpose computer, such as a DEC Alpha processor running VMS and each connected to a Shared Disk Array memory storage device 56. As shown in FIG. 2, two DAP sites 70a, 70b are provided with each DAP site comprising one or more transaction servers 75 and communication servers 76 that are to be monitored for various alarm messages. Although two DAP sites are shown in FIG. 2, it is understood that many sites may be monitored in accordance with the principles of the invention. Preferably, each of the transaction servers 75 and communication servers 76 comprise a computer, such as DEC Alpha 4100 servers running an open VMS operating system, and each provided with a console port, with console ports 81-84 depicted in FIG. 2. It should be understood that these servers may also include DEC VAX and DEC HSJ type servers. Additionally, as shown in FIG. 2, provided at each respective DAP site is a terminal server 80a,80b provided to enable remote access to transaction servers and communications servers, as will be described. The transaction servers 75 and communication servers 76 being monitored by NAMS 50 will be hereinafter referred to as “monitored element” or “monitored system” and each NAMS Server 55a,b may be referred to herein as an NCS Alarm Monitoring Host (“NAMH”) with the dual server system referred to as an NCS Alarm Monitoring Cluster (“NAMC”).

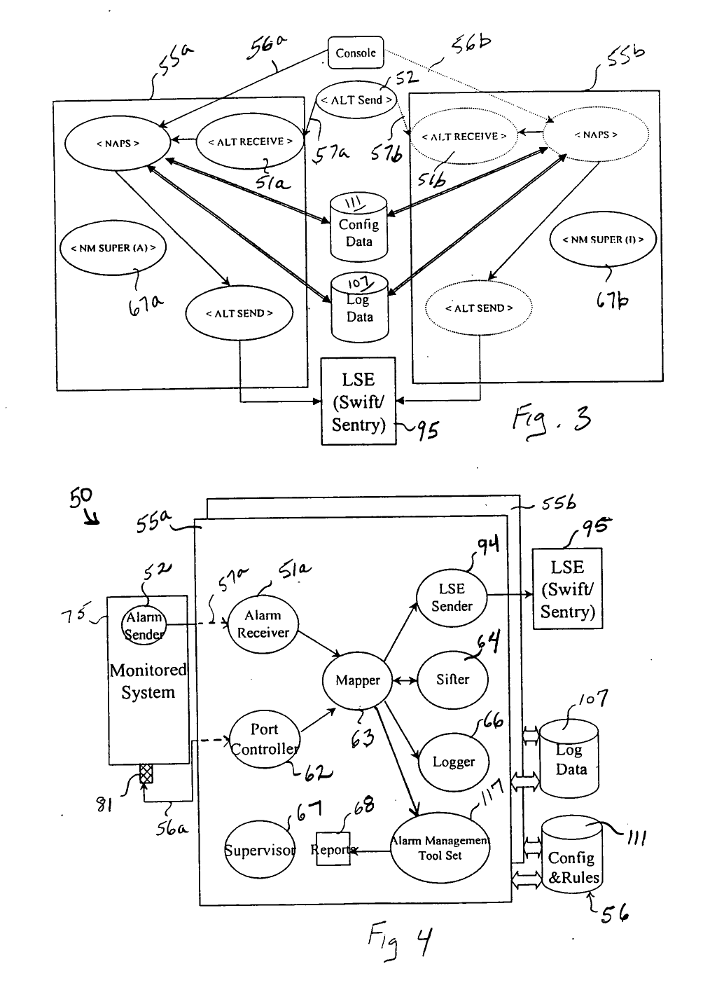

Preferably, the NAMS platform 50 asynchronously receives data from two source types: 1) console connections; and 2) application connections. As shown in FIGS. 2 and 3, a console connection is implemented at each DAP site 70a,b by establishing a telnet session to any terminal server 80a,b which supports telnet. Typical telnet servers include the DEC server 90 and 700 series terminal servers. Each terminal server provides a physical connection to each of the console ports 81-84 of the various monitored element/systems using, for example, an RS-232 compliant connection to enable real-time monitoring thereof. Essentially, each terminal server 80a,b serves as a multiplexer for the plurality of monitored element/systems, and further provides access to the console port I/O 56a,b of each monitored element/system. Although FIG. 2 illustrates one terminal server per DAP site, it should be understood that there may be one or more Terminal Servers for each DAP site, depending on the number of monitored element/systems at a DAP site.

Each terminal server 80a,b further connects the monitored element (server) console ports 81-84 to a network 99 (e.g, Ethernet WAN, LAN, and/or FDDI, etc.) implementing any one of several communications protocols such as DECNet™ (from DEC), Local Area Transport (LAT, also from DEC), Telnet (which rides on TCP/IP), etc. In the preferred embodiment, Telnet over the network 99 is used. Particularly, in the preferred embodiment, an IP address is assigned to each Terminal Server 80a,b and a Telnet port address is mapped to each back-end port of a Terminal Server, e.g., ports 86 and 87 at DAP site 70a corresponding to the console ports 81 and 82 of a monitored element/system. In this manner, the console port 81-84 of each DAPServer can be accessed via Telnet over the network 99, using the Terminal Server at the DAP or SCM site.

In accordance with the invention, each monitored element/system server's console port, e.g., 81-84, is accessed to monitor the operation of both the operating system and the applications executing on that monitored system element server. Specifically, a monitored element/system server's operating system and executing applications each write event messages to the monitored element's server console port, which messages are preferably text messages written to the console port for transmission over the WAN 99 via the Terminal Server. The console port interface (not shown) provides accessibility to these messages at times when a network port interface on the same monitored element/system may not work; thus providing more reliability for monitoring alarms. It should be understood that data delivered via the console I/O telnet typically comprises ASCII text in an unstructured format. Consequently, this data is mapped to a “higher” order of structure (“Alarms”) by a NAMS mapping process, as will be explained in greater detail herein.

Additionally, as shown in FIGS. 2 and 3, each NAMS server 55a,b is designed to receive system applications alarm messages from a network connection such as a NCS monitored element/system's Log Management Facility (“LMF”) for DEC systems utilizing DECNet™ or TCP/IP connections, which LMF messages can be transmitted to NAMS servers over the same physical path as console messages, or, over, preferably, via separate LMF links 57a,b such as shown in FIG. 2. As shown in more detail in FIG. 3, application connections are implemented by the use of DECNet, VMS Mailboxes, and TCP/IP BSD sockets and the “Alarms” messages are delivered to a NAMS platform's “ALT Receive Mailbox” 51a,b by a VMS process on a monitored element/system known as “<ALT SEND>” 52. The applications on a monitored system use an LMF application program interface (API) which is configured to notify “<ALT SEND>” of alarms which require delivery to the NAMS platform 50. The VMS process “<ALT RECEIVE>” is responsible for retrieving application Alarms from its mailbox or BSD socket and delivering it to the “<NAPS>” process for alarm message monitoring.

As further illustrated in FIG. 2, there is shown a second network 98 employed to connect the NAMS Servers 55a,b to an IP Network 90, such as a corporate Intranet or the public Internet for transmitting messages to various client entities. For example, the NAMS Servers are provided with the capability of initiating transmission of an e-mail message in response to a recognized alarm condition. Via the network 98, the NAMS Servers may access an E-mail Server 70 for issuing the e-mail messages, as will be described. It should be understood that the first network 99 could be used as well to transmit messages over the IP Network 90. The network 98 additionally connects the NAMS Servers 55a,b to an X.25-based Operational Support System network (OSSNet) 92 which is utilized to transmit qualifying alarms to a Local Support Element 95 (“LSE”). The LSE network 95 is a network element capable of receiving messages from many different types of equipment in the telecommunications network and forwarding these messages to various downstream systems. In the context of NAMS, the LSE 95 receives qualifying alarms from NAMS Servers 55a,b and forwards them to one or more Network Management and Alarm Monitoring Systems 100 for presentation to network management personnel.

Preferably, connected to the IP Network 90 are a plurality of client computers or workstations, e.g., PCS 60 and Telnet terminals 65, each of which running a graphical user interface (“GUI”) to provide for the real-time presentation of alarms and further enable user configuration and modification of NAMS server processes utilized for alarm presentation. In the preferred embodiment, these functions are encapsulated in a Java™-based application referred to as an Alarm Monitoring Tool Set (“AMTS”) which is a set of report and alarm presentation tools that can be stored on the NAMS Server as Java™ applications that can be downloaded to a Java™-capable client shown as PC 60 via the IP network 90 when requested by a user. Alternately, the AMTS can also be stored on another host computer (not shown) that is accessed via the IP network. In this way, any Java™-capable computer can be used as a client PC provided that access permissions to the host computer over the IP network are granted without the requirement of pre-loaded software. Another alternate embodiment is to-have a client PC pre-loaded with the AMTS application, or, have the AMTS application execute on the NAMS Server with presentation windows “pushed” to any X-windows capable terminal (e.g., NCD's PC-Xwave or the common Desktop Environment for Unix and VMS).

As mentioned herein, each NAMS Server 55a,b provides alarm monitoring and console access and logging for each monitored element/system at each DAP site. FIG. 4 illustrates a data flow diagram depicting preferred alarm monitoring processes, i.e., “<NAPS>” processes, employed by the NAMS server. As shown in FIG. 4, there is provided a PortAgent process 62 which may be a C++ object or like equivalent that is instantiated to: 1) establish a Telnet connection to a single terminal server port physically connected to the monitored system console ports; 2) receive messages from the terminal server telnet port and create a “Message” which is delivered to a “Mapper” process 63 for further processing; and 3) control access to the monitored system by functioning as an active pass-through to the terminal server ports. Typically one PortAgent process 62 is instantiated per monitored system with a portAgentManager object (not shown) responsible for the creation of all PortAgents and handles management of the PortAgents.

The NAMS server “Mapping” process 63, preferably, is a C++ object or like equivalent that is instantiated to: 1) translate received ASCII text messages into an alarm if the alarm meets confirmable alarm criteria; and, 2) associate “Actions” with translated alarms. Particularly, as shown in FIG. 4, a NAMs server 55a,b, is provided with a mapper configuration file 111 that is stored on a shared disk array 56 for storing the user-specified rules. These rules are read by the mapper process 63 and applied to each received message to determine whether a message is to be considered an “Alarm” indicating that a recognized event occurred on a monitored element/system. In a preferred embodiment, typical “Actions” include saving the text message to an alarm log database file 107 and forwarding an alarm message to the LSE 95 via an LSE send process 94.

Further shown in FIG. 4, is a “Sifter” Process 64 which is invoked by the mapping process to sift alarms that come to the NAMS system either by the console connection or by LMF. Its purpose is to manage alarm traffic by defining matching criteria for dropping alarms. For example, if an alarm is sent through the Sifter, as determined by the ACTION associated with the detected event in accordance with the mapper configuration file, the alarm will be sifted (dropped) if it matches any configuration item in a sifter configuration file stored in the configuration and rules database 111a. Typically, this means that if the sifter matches an alarm, that alarm will not be sent to the downstream LSE element 95.

Other important NAMS server-based applications include:

a “Logger” process 66 communicating with the mapper process 63 and provided to enable the writing of various alarm message text as persistent data to log/data memory storage disk 107 as depicted in FIG. 4. The log/data memory storage disk 107 may be configured to provide persistent storage of other information including: alarm information containing, for example, all recognized alarms that have been processed; raw text message (ASCII) information alarm processor information containing, for example, all events specific to NAMS, e.g., messages invoked when a NAMS server goes down; logged console port information; and, dropped (sifted) alarm information containing, for example, information that has been received by NAMS via the <ALT RECEIVE> mailbox, but could not be processed;

a “Supervisor” process 67 that is used to start and stop specific applications and ensure that given processes are running on the system (controlled by a configuration file). In the preferred embodiment, there are multiple NAMS servers 55a,b active at one time to maximize CPU/ I/O rates;

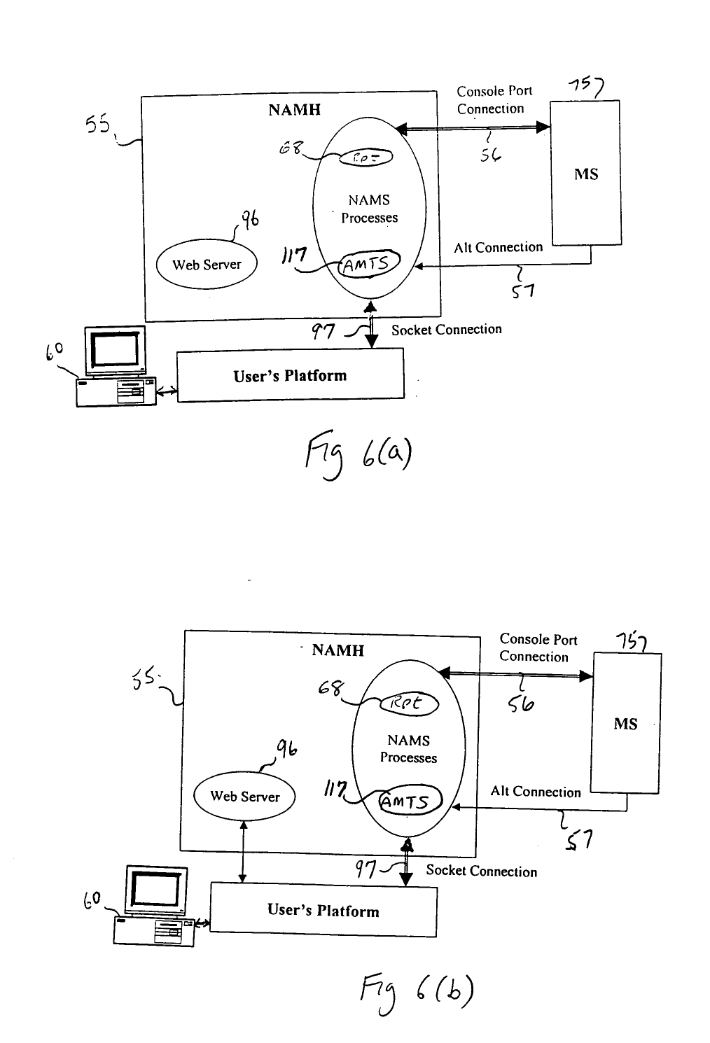

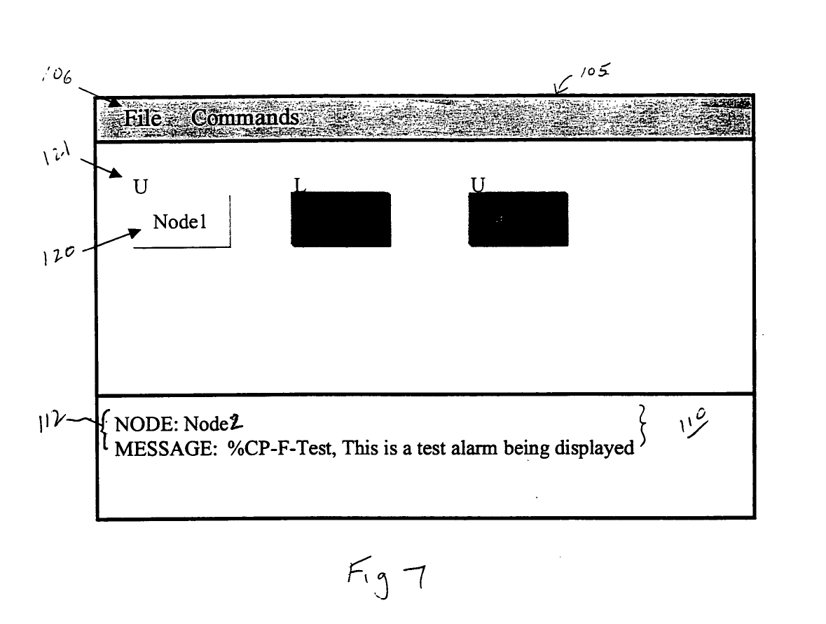

an Alarm Management Tool Set (“AMTS”) server process 117 which communicates with each of the other processes to provide a “monitored system map” enabling a user to achieve a real-time view of the monitored network by displaying the alarm status of each monitored element/system locally, via the telnet server and terminal or, remotely, via a client PC or telnet terminal over a TCP/IP connection. Particularly, as will be described with reference to FIGS. 6(a) and 6(b), the AMTS server process 117 in NAMS 55 performs at least three functions: 1) provides access to all alarms on the NAMH system by providing a display of alarms currently being processed on the NAMH as well as alarms processed in the past; 2) provides a mechanism whereby a user can create and specify configuration rules to be stored in the configuration file 111 for use by the NAMS “Mapper” and “Sifter” process; 3) allows user to access a console port directly, via a NAMS server via a local terminal server connection or remote client PC/Telnet connection; and 4) provides notifications of monitored system events, e.g., active, inactive, locked and unlocked; and notifications of monitored system service requests, all via PC/telnet clients using TCP/IP communications;

a report generator object 68 in communication with the AMTS process 117 which obtains alarm information for client reporting and presentation. Particularly, this is achieved by a parsing mechanism which parses the alarm log/data storage 107 in accordance with search queries that are constructed in accordance with the syntax used in applying the mapper configuration rules as described herein. In the preferred embodiment, each of these processes are C++ applications.

As described herein, the Mapper configuration file 111 is responsible for controlling how and what messages/alarm processing is performed on data sent to the NAMS platform 50. The primary components encapsulated by this configuration file is an “Event” definition. Event Groups encapsulate Event Definitions in order to streamline processing and typically include only Events which pertain to a specific class of machine as will be explained. Data received from the “<ALT RECEIVE>” connection 51a,b (FIG. 3) is automatically assigned to the LMF group and each console which is being monitored is associated to the Event Group defined in a console Configuration file (not shown).

With more particularity, in the preferred embodiment, the configuration files ill includes the rules that are used to match alarms that come to the NAMS system either by a console connection or by LMF. Particularly, its purpose is to enable the NAMS system 50 to recognize and parse an alarm, determine if the alarm should be processed, and then assign actions to that alarm that will determine how that alarm is handled by the system. The mapper configuration file is broken into a series of configuration elements and is separated into EVENTs and EVENT_GROUPS. Events are individual mapping entries, and event groups are comprised of events and other event groups. In mapping a console or LMF message, the message is configured to a specific event group, then those events are sequentially traversed until a match is located. If no event matches the message text, that message is dropped.

An example event format is as shown:

| | |
|---|---|
| EVENT = | EVENT_NAME,- |
| | TIME = “$ALL”,- |
| | HOST_ID = “$ALL”,- |
| | PROCESS_NAME = “$ALL”,- |
| | FACILITY = “$ALL”,- |
| | SEVERITY = “$ALL”,- |
| | MNEMONIC = “$ALL”,- |
| | DESCRIPTION = “$ALL”,- |
| | ACTION = “if SIFTER then LSE_SEND; SAVE” |

Thus, a configuration element in the configuration file ill can be used to match on fields containing the following alarm attributes:

TIME, i.e., the epoch in VMS format, e.g., “19-JAN-1998 14:17:37.97”;

HOST_ID, i.e., the machine name the alarm originated, e.g., TSTX01;

PROCESS_NAME, i.e., the process name that generated the alarm, e.g., “<CVN00_I>”;

FACILITY, i.e., the VMS facility name, e.g., “TERMDF”;

SEVERITY, i.e., the VMS severity level of the alarm, e.g., “W” for a warning alarm;

MNEMONIC, i.e., the mnemonic representation of the alarm, e.g., “CONV_TIMED OUT”; and

DESCRIPTION, i.e., the text description of the alarm.

It should be understood that additional alarm attribute fields upon which a configuration element may match include: ENTRY POINT—which is populated with the designation “console” or “LMF” depending upon how the message is communicated to NAMS; FUNCTION—which designates the function performed by the DAP Server that generated the message; for example, “TS N00” identifies a Transaction Server, “CS” identifies a Communication Server, “ICR” identifies an Intelligent Call Router, “SCM” identifies a Server Control Manager, etc.; SERVER—which designates the Terminal Server from which the message was forwarded; and PORT—which designates the port of the Terminal Server connected to the monitored element/system server that generated the message. In the preferred embodiment, both the messages received from Monitored element/systems and the rules in the Configuration File are in ASCII text. In this way, the invention lends itself to the use of non-proprietary technology, enabling portability to many different platforms.

Each alarm attribute item is an extended regular expression (governed by I.E.E.E. Std 1003.2-1992) and can be used to match alarms. Any unspecified alarm attribute defaults to “.*” which will always match on that attribute. It should be understood that macros may be employed to increase the readability of the configuration files by providing simple text substitutes such as:

$ALL

$FATAL

$ERROR

$WARNING

$INFORMATIONAL

$SUCCESS

For example, to search for both fatal and error alarms, the following are equivalent:

SEVERITY=“[$FATAL$ERROR]”

SEVERITY=“[FE]”

That is, both items search for the VMS Severity of Error (“E”) or Fatal (“F”). In particular, the $ALL macro is simply a substitute of “.*” which matches on all text.

The other essential part of a configuration element is the Action list which dictates how the NAMS system 50 will process a matched alarm. In one embodiment, an expected Action list for the majority of matched alarms is as follows:

ACTION=“if SIFTER then LSE_SEND; SAVE”

This command informs the NAMS system to first sift the alarm by the sifter process 64. Particularly, a SIFTER configuration element is invoked to sift alarms that come to the NAMS system either by a console connection or sent by LMF. Its purpose is to manage alarm traffic by defining matching criteria for dropping alarms. If an alarm is sent through the sifter (determined by the ACTION list in the mapper configuration file), the alarm will be sifted (dropped) if it matches any configuration item in the sifter configuration file. In the preferred embodiment, a sifter configuration file is broken into a series of configuration items. Each item acts individually, and the first item that successfully matches the alarm is used so that any other later items are ignored. As an example, a sifter configuration element can be used to match on the TIME, HOST_ID, PROCESS_NAME, FACILITY, SEVERITY, MNEMONIC, and DESCRIPTION alarm attributes. A sample entry is as follows:

| | |
|---|---|
| ENTRY = | SIFTER_ELEMENT,- |
| | TIME = “$ALL”,- |
| | HOST_ID = “$ALL”,- |
| | PROCESS_NAME = “$ALL”,- |
| | FACILITY = “$ALL”,- |
| | SEVERITY = “$ALL”,- |
| | MNEMONIC = “$ALL”,- |
| | DESCRIPTION = “$ALL” |

with each item being an extended regular expression.

If the sifter does not drop the alarm then it is sent to the LSE 95 for downstream processing. After this is done, the alarm is saved. In the preferred embodiment, the alarm is logged regardless of the status of the sifter. Thus, the tokens and syntax of the ACTION field are:

SAVE—log the alarm to a pre-defined directory, which is created each day, for example, for archival/reporting purposes;

LSE_SEND—send the alarm to LSE;

COMMAND filename[, filename]*—executes one or more DCL command procedures specified by ‘filename’, passing them all alarm attributes;

( )—parenthesis indicates grouping of tokens together;

“if-then”—this pair is used to establish a cause and effect relationship between a conditional action and an action statement;

SIFTER—send the alarm through the sifter and act upon the result. Currently, this is the only conditional action and is used in an if-then block; and,

(semi-colon)—which establishes a separate sequence of actions that are always sequentially executed regardless of the status of previous action blocks.

As a first example, the ACTION field:

ACTION=“if SIFTER then LSE_SEND; SAVE”

exemplifies how the semi-colon separates the if-then block from the SAVE block so that after the if-then block is executed, the alarm is then always logged since the SAVE block always executes. The SIFTER is the conditional action of the if-then block so that if the SIFTER doesn't drop the alarm, the alarm will be sent to LSE_SEND process 94 (FIG. 4).

As a second example, the ACTION field:

ACTION=“if SIFTER then (LSE_SEND; SAVE)”

exemplifies use of the parenthesis to group the LSE_SEND and SAVE tokens into the same block. Thus, if the SIFTER does not drop the alarm, it will then get sent to LSE and logged. But if the SIFTER drops the alarm, unlike the first example, it will not be logged.

It should be understood that this syntax permits the introduction of many tokens, thus adding more features to the system. One example would be the automatic triggering of an e-mail message, however, use of COMMAMD is more likely because it may be directed to send an e-mail. Thus, an E-MAIL token can be added to the Action list, which would trigger the transmission of data comprising the alarm message text and destination E-mail address to the E-mail Server 70 to notify operational support personnel of a negatively impacting alarm condition, for example. As shown in FIG. 2, the triggering of an E-mail ACTION item token will additionally generate an e-mail process 72 running on an E-Mail server 70 to enable forwarding of the alarm message text to a destination client via an IP Network 90, at that destination e-mail address. Alternately, a token in the Action list may be used to trigger an automatic page in a telecommunications paging system.

The following is a sample configuration element that can be used to match on all Fatal alarms and assign an Action list to them.

| | |
|---|---|
| EVENT = | SAMPLE_EVENT,- |
| | SEVERITY = “$FATAL”,- |
| | ACTION = “if SIFTER then LSE_SEND; SAVE” |

Since, in this example, only the Severity is being matched specially, all other attributes can be defaulted. It should be understood that different configuration rules can be used for each type of action. For example, a medium-severity alarm may only be written to the Alarm Database 107, while a high-severity alarm may be written to the Alarm Database 107 and sent to the LSE and downstream network alarm monitoring systems.

To increase the functionality, an event “group” scheme may be formatted as follows:

EVENT_GROUP = EVENT_GROUP_NAME,-
EVENTS = (EVENT1,-

EVENT2) ,-

EVENT_GROUPS = (EVENT_GROUP1,-

EVENT_GROUP2)

This scheme is simply a way to logically group events so that a data stream that is received by a site will only be matched against a subset of events instead of the entire list. For example, the VAX 4000 series computers will produce output to its console which only pertain to a VAX 4000 type machine. The Event Group is thus an efficiency mechanism which prevents the mapper process 63 from ever comparing non-VAX 4000 specific console notifications from ever being considered for processing, because these types of notifications will never be sent to the console. An event group specifies the events that belong to it in addition to other event groups. Any events that belong to those other event groups will get incorporated into the current event group, however, all events and event groups referenced must be defined prior to this event group definition.

Additional features that may be added to the EVENT definitions include: 1) attribute overrides which provide a manner in which VMS attributes of a matched alarm can be replaced; and, 2) mapping rule overrides which enables customization of rules for-mapping to an alarm to allow the NAMS system 50 to correctly process messages received by a particular system that, for example, does not adhere to the VMS alarm system format.

With regard to the attribute override function, it will be invoked only when an alarm has been matched and it is desired to replace its VMS attributes. For example, when an alarm that is frequently being triggered is of Fatal severity, it may be desirable to set that alarm as only a Warning. There are four (4) tokens that can be used, and if any are present in a configuration element, they are simply substituted for the attribute in the alarm. These are the four (4) available tokens:

OVERRIDE_SEVERITY=“X”

OVERRIDE_FACILITY=“XXX”

OVERRIDE_MNEMONIC=“XXX”

OVERRIDE_DESCRIPTION=“XXX”

with “X” representing the override value in the configuration element.

With regard to overriding mapping rules, by default, the NAMS system maps VMS alarm attributes from a character stream in standard VMS format (% FACILITY-SEVERITY-MNEMONIC, DESCRIPTION). For instances when alarms are received from a system that does not adhere to this standard, the rules for mapping an alarm can be customized to allow the NAMS system to correctly process messages received by this system. Extended regular expressions with sub-expressions are used for mapping these attributes, and these can be customized using the following tokens: Note that the following values are the defaults so that only values that differ from these need to be defined.

MESSAGE_CRITERIA=“%([A-Z_]+)−([A-Z]+)−([A-Z_]+), (.*)”−

MAP_FACILITY=“\1”

MAP_SEVERITY=“\2”

MAP_MNEMONIC=“\3”

MAP_DESCRIPTION=“\4”

Particularly, the NAMS system filters and sifts alarms based on facility, severity, mnemonic, and description attributes. Even if the non-standard system does not provide an attribute, a mapping rule must be provided for the alarm. In the MESSAGE_CRITERIA field, parenthesis “( )” are used to separate regular expression blocks. These are sub-expressions and are used to identify text segments for mapping into attributes. For example, the first section, “%([A-Z_]+)−”, maps all uppercase and underscore characters between the “%” and “−” characters. Those characters represent the Facility in a VMS-styled message. The MAP_FACILITY token indicates how to use the MESSAGE_CRITERIA expression to map the Facility. For example, the suffix “\1” indicates that the first sub-expression is used to locate the characters for the Facility attribute. This is the default, and the remaining three attributes, i.e., SEVERITY, MNEMONIC, and DESCRIPTION, have suffixes indicating which sub-expression in MESSAGE CRITERIA maps the attribute text. If the NAMS system is monitoring a node that is going to send console alarms in a different format, these mapping fields can be used to map attributes. If an attribute can't be mapped by the text given, it must be defaulted to a text string.

It should be understood that this mechanism can also be used as an attribute override. If it is decided that alarms from a particular system should always use a particular facility, then the MAP_FACILITY can be used to accomplish this:

MAP_FACILITY=“FORCED_FACILITY”

This is similar to using an OVERRIDE_FACILITY of

OVERRIDE_FACILITY=“FORCED_FACILITY”

except that the MAP_FACILITY function is done prior to attribute matching while the OVERRIDE_FACILITY function is done after attribute matching.

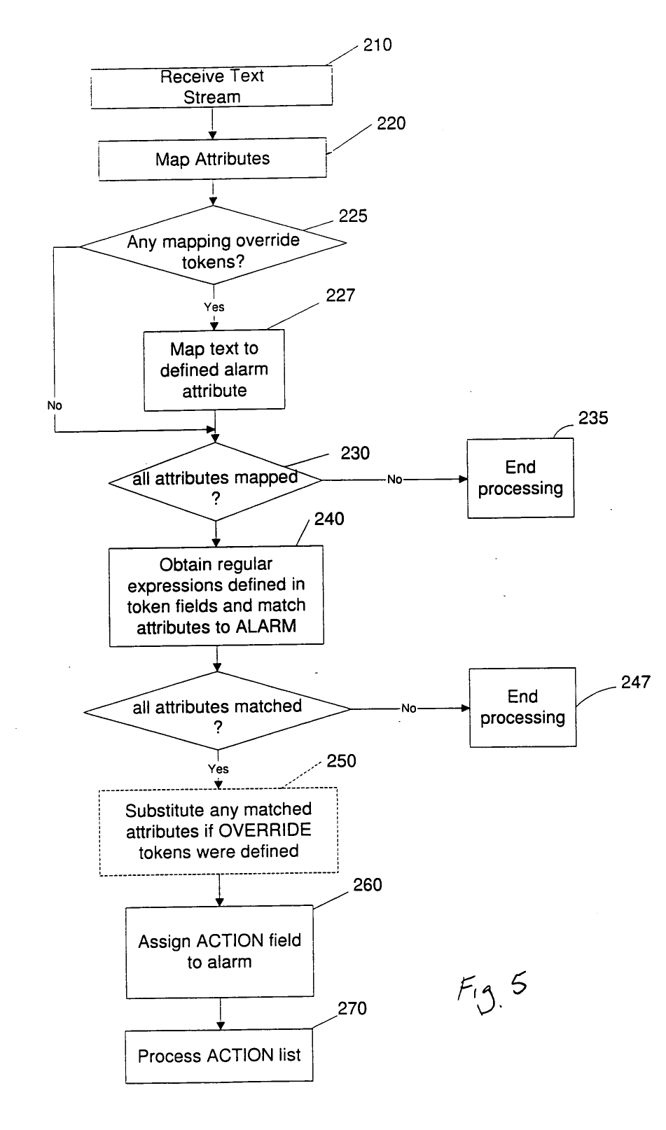

FIG. 5 illustrates a general flow diagram depicting the steps invoked by the NAMS server 55 for processing the text messages from the console I/O or LMF application. As shown at step 210, that first step is to receive the text stream data from the PortAgent process for Console I/O message streams, as these text streams typically are unstructured messages. Then, at step 220, the attributes are mapped by the Mapping process 63 implementing the configuration rules. It is typically the case that alarm event attributes such as TIME, HOST_ID, and PROCESS_NAME are already known when a message reaches the NAMS platform. Attributes such as FACILITY, SEVERITY, MNEMONIC, and DESCRIPTION are determined by using default parsing criteria when mapping rule override tokens are not defined. Thus, a check is made at step 225 to determine if there are mapping rule override tokens defined in the configuration element. If there are mapping rule overrides, then the received text is mapped to the particular alarm attribute as defined in the MESSAGE CRITERIA token, as indicated at step 227.

If no mapping rule overrides are present, then the process continues to step 230 where a determination is made as to whether all attributes have been mapped. If all attributes could not be mapped, then this data stream is not a valid alarm and processing for this configuration element stops, as indicated at step 235. If the attributes have all been mapped, then, at step 240, the regular expressions defined in the token fields are obtained and an attribute matching step is performed.

As indicated at step 245, a determination is then made as to whether all attributes have been matched. If all attributes could not be matched, then this data stream is not a valid alarm and processing for this configuration element stops, as indicated at step 247. If the attributes have all been matched, then the optional step 250 may be performed to override any matched attributes if OVERRIDE tokens are defined in the configuration element. That is, for any OVERRIDE_FACILITY, OVERRIDE_SEVERITY, OVERRIDE_MNEMONIC, or OVERRIDE_DESCRIPTION tokens defined, they are used to substitute for the mapped attributes they represent. Once all attributes are known, then at step 260, the ACTION field is assigned to the alarm. Finally, as indicated at step 270, the ACTION list is processed.

In addition to the typical response “Actions” of writing alarm messages to an Alarms Database 107, (FIG. 4), or sending it to the LSE 95 and downstream network management systems 100 over the X.25 OSSNET 92 (FIG. 2), or dropping the message via the SIFTER.

FIG. 6(a) illustrates the general architecture for the AMTS alarm monitoring tool set 117 that enables the presentation of alarm data from the NAMS server 55 to a client PC terminal 60 via a socket connection 97. In the embodiment depicted in FIG. 6(a), local access to the NAMS server 55 is provided via the TCP/IP socket connection. In the embodiment depicted in FIG. 6(b), Web access is provided by downloading an AMTS GUI from a Web Server 96 to the client PC/terminal 60 to enable a user to receive NAMS alarm information for monitoring system alarm conditions.

Particularly, in the embodiment of FIG. 6(b), via a Web browser, a client PC application is downloaded to provide access to view alarms currently being processed on the NAMS server as well as alarms processed in the past depending upon the available alarm archives. In the preferred embodiment, the AMTS system provides a platform-independent browser application, e.g., written in Java™, that executes on a standard PC, and can either be downloaded on-demand to a client PC, or permanently stored on a client PC (assuming existence of a Java™ 1.1 Virtual Machine) at the user platform, or, can execute on a NAMS Server with presentation windows being pushed to a client PC. It should be understood that the AMTS application may be written in other portable, platform-independent languages.

Alternately, through the PortAgent process 62 running on NAMS server 55, messages that are written to each monitored system/element server's console port 81-84 (FIG. 2) may be directly accessed from the Telnet Terminal 65 over a Telnet connection. The PortAgent process on NAMS enables multiple users to read and write messages written to a console port, and one user to write and write messages to the same console port. Using the Telnet Terminal 65 (FIG. 2), a user can write (using TCP/IP) to a NAMS Server. From the NAMS Server 55, a user then connects to a monitored system. In this way, using a specific Telnet address, a user can remotely access the console port.

FIG. 7 illustrates the AMTS screen display 105 for the presentation of alarms received from the monitored system. As shown, the screen display provides a menu bar 106 for implementing various commands, such as a command to “attach” to a monitored element/system, for example when necessary to perform monitoring or diagnostics. A lower part of the display 110 is a scrollable area presenting text 112 indicating the monitored element/system element is experiencing an alarm condition, and the actual alarm message. An upper part of the display 115 presents the same corresponding alarm message as icons 120, which, in the preferred embodiment, are color-coded to represent severity levels. Above each icon, are “U” and “L” indicators 121 representing monitored system elements that are respectively, unlocked or locked. For instance, as shown in FIG. 7, Node 2 (monitored element) may be presented as a red icon to indicate a fatal severity level. A user, when presented with such an alarm condition, can mouse-click the node, and select the “attach” command to access the actual console port of the node experiencing this alarm, to ascertain the cause of the alarm and take further corrective action.

Additionally, an alarm report generator is provided by implementing the AMTS process 117 and the report generator process 68. Such a report generation feature is provided as a standalone feature on NAMS, or may also be one ATMS application tool that may be downloaded via a Web server, or reside as a Java™ application on the client PC. The report generation feature is provided with the capability of providing reports based upon user-selected search and display parameters.

The search parameters define the rules to be applied to the alarms received by the NAMS and are based upon alarm attributes, e.g., site, monitored system type, severity, process identifier, facility, system identifier, timestamp, alarm identifier sifted for a destination, and NAMs alarm entry point. The display parameters define the alarm report fields to be displayed, e.g., NAMS alarm entry point, sifted for a destination, timestamp, site, monitored system type, facility, severity, alarm identifier, process identifier, system identifier, alarm identifier, and alarm text. The alarm report parameter selection has a GUI interface that is similar to the interface depicted in FIG. 7.

In the preferred embodiment, a configuration file for the report_generator application provides the search criteria that will be used to match alarms in the alarm log stored in log/data memory storage 107 (FIG. 4). All matching alarms will be sent to an/OUTPUT=argument or to SYS$OUTPUT if /OUTPUT=is not provided. Preferably, the report generator configuration file matches on all Fatal alarms, however, it is capable of matching on a different criteria by copying the file to another name, editing it, and running the REPORT_GENERATOR application pointing a /CFG=argument to the new file having the new search criteria.

According to the invention, the AMTS application 117 additionally enables a user to create and configure rules that are used by the NAMS “mapper” and “sifter” processes to take appropriate actions on messages. These rules specify, for example, how a NAMS server 55a,b is to discriminate alarms from all messages read and assign severity levels; and which actions NAMS is to take on which alarms. For example, configuration rules may state that any message with a severity level=fatal/error/warning, is to be written to the Alarm log/data storage disk 107, and any message with a severity level=fatal, is to be sent to the LSE. Single or multiple actions may be taken on any particular message type.

In a preferred embodiment, by the remote access mechanism described with respect to FIGS. 6(a) and 6 (b), a user can access configuration files stored in the configuration and rules database 111 of the NAMS (FIG. 4). When provided with a text editor (not shown) a user can edit the existing rules in the configuration file, or create and enter new rules. As shown in FIG. 6(a), these rules are entered via the AMTS GUI interface -and communicated, for instance, over the IP Network, for storage in the Configuration File 111 at NAMS Servers 55a,b.

The foregoing merely illustrates the principles of the present invention. Those skilled in the art will be able to devise various modifications, which although not explicitly described or shown herein, embody the principles of the invention and are thus within its spirit and scope. For instance, the ATMS process may be provided with an application to enable a user to query the log/data memory storage disk to obtain relevant system alarm data or other alarm information. Via a front-end user interface to NAMS, such as illustrated in FIG. 6(b), a user may perform a database query via an AMTS tool functioning as a database server. Specifically, through the AMTS browser interface, a user can issue queries on the NAMS server to access the NAMS log/data memory storage, for instance, to obtain certain or all types of alarms based on the above-mentioned search and display parameters; for example, alarms from specific Monitored element/systems or sites, alarms that occur during a specific time period, or alarms of a specific severity level, etc. The results of these queries can be formulated in the NAMS AMTS tool with the results returned to AMTS client.

What is claimed is:

1. In a communications network having one or more network elements capable of generating various messages having attributes indicating the existence of an alarm condition, an apparatus for remotely monitoring alarm messages comprising:
first means for receiving communication of original textual messages generated from one or more network element subsystems the network element subsystems including console connections and application connections;
means for mapping text of a received original message to one or more of a plurality of alarm attributes;
means for determining the presence of an alarm condition from said one or more attributes and generating one or more responses according to said type of alarm condition; and,
means for enabling a remotely located user access to said one or more network elements via a display interface at a remote terminal, said response including automatically presenting said remotely located user of an alarm condition at a network element via said display interface, said remotely located user being enabled to access said network element from said remote terminal for further responsive action thereof.

2. The apparatus as claimed in claim 1, wherein said first server means includes a terminal server means physically connected to a console port I/O of each said network element, said remotely located user having access to said console port via said user interface.

3. The apparatus as claimed in claim 1, wherein said first server means includes means for receiving communication of original textual messages from a network application running on said network element, said first server means including a mailbox facility means for receiving said alarm messages.

4. The apparatus as claimed in claim 1, wherein said network application running on said network element is a Log Management Facility application.

5. The apparatus as claimed in claim 1, further comprising means for presenting an indication of said alarm condition to said remotely located user via a network connection.

6. The apparatus as claimed in claim 5 wherein said indication of said alarm condition is presented as on said display interface as a graphical icon, said graphical icon being color-coded to indicate alarm condition severity.

7. The apparatus as claimed in claim 2, wherein said terminal server means includes a telnet terminal server.

8. The apparatus as claimed in claim 7, wherein said means for enabling a remotely located user access to said one or more network elements includes a network connection.

9. The apparatus as claimed in claim 7, wherein said network socket connection is pursuant to a TCP/IP protocol.

10. The apparatus as claimed in claim 1, wherein said means for mapping text of a received original message to one or more of a plurality of alarm attributes includes utilizing regular expression matching.

11. The apparatus as claimed Mi claim 1, wherein said message attributes include one or more selected from the group comprising: originating network element, time, alarm severity level, alarm mnemonic, alarm description, process name, and network element name.

12. The apparatus as claimed in claim 11, wherein said means for determining presence of an alarm condition from said one or more attributes includes means for applying configuration rules to said alarm attributes, said configuration rules stored as text in a first storage means at or near said first means and accessible therefrom.

13. The apparatus as claimed in claim 12, further including text editor means for enabling a user to modify existing configuration rules stored in said storage means via said user display interface, said text editor means further enabling said user to generate new configuration rules for storage in said storage means, said new configuration rules creating a new alarm condition.

14. The apparatus as claimed in claim 12, wherein said configuration rules further provides a sifting operation for sifting through said attributes to match said alarm condition with a pre-determined alarm condition.

15. The apparatus as claimed in claim 14, wherein said sifting means operation enables an alarm message to be terminated if a match with a pre-determined alarm condition is found.

16. The apparatus as claimed in claim 12, wherein said configuration rules further provide a logging operation for automatically logging alarm conditions in a second storage means at or near said first means and accessible therefrom.

17. The apparatus as claimed in claim 16, further including means for generating reports including past alarm conditions stored in said second storage means.

18. The apparatus as claimed in claim 1, wherein a response action includes initiating transmission of an e-mail message and command procedure.

19. The apparatus as claimed in claim 1, wherein a response action includes initiating transmission of a paging message and command procedure.

20. The apparatus as claimed in claim 1, wherein said physical connection to said console port I/O includes an RS-232 link.

21. (Amended) In a communications network having one or more network elements capable of generating various messages having attributes indicating the existence of an alarm condition, a method for remotely monitoring alarm messages comprising:
receiving communication of original textual messages generated from one or more network element subsystems the network element subsystems including console connections and application connections;
mapping text of a received original message to one or more of a plurality of alarm attributes;
determining the presence of an alarm condition from said one or more attributes and generating one or more responses according to said type of alarm condition; and,
enabling a remotely located user access to said one or more network elements via a display interface,
wherein a response includes automatically presenting said remotely located user of an alarm condition via said display interface, said remotely located user capable of accessing said particular network element generating said alarm condition for further responsive action thereof.

22. The method as claimed in claim 21, further including providing a physical connection between each said network element and a terminal server device enabling remote access to said one or more network elements via said user display interface.

23. The method as claimed in claim 21, further including providing a mailbox facility means for receiving said alarm messages, and retrieving said messages from said mailbox facility prior to said mapping step.

24. The method as claimed in claim 21, further including providing a network connection to enable presentation of said alarm condition to said remotely located user, said alarm condition being presented on said display interface as a graphical icon.

25. The method as claimed in claim 24, wherein said graphical icon is color-coded to indicate alarm condition severity.

26. The method as claimed in claim 21, further including providing a network socket connection to enable said remotely located user access to said one or more network elements.

27. The method as claimed in claim 26, wherein said network socket connection is pursuant to a TCP/IP protocol.

28. The method as claimed in claim 21, wherein said step of mapping text includes utilizing regular expression matching.

29. The method as claimed in claim 21, wherein said message attributes include one or more selected from the group comprising: originating network element, time, alarm severity level, alarm mnemonic, alarm description, process name, and, network element name.

30. The method as claimed in claim 21, wherein said determining step includes applying configuration rules to said alarm attributes, said configuration rules being stored as text in a first storage means at or near said first means and accessible therefrom.

31. The method as claimed in claim 30, further providing text editor means for enabling a user to modify existing configuration rules stored in said storage means via said user display interface, said text editor means further enabling said user to generate new configuration rules for storage in said first storage means, said new configuration rules creating a new alarm condition.

32. The method as claimed in claim 30, wherein said step of applying configuration rules further includes performing a sifting operation for sifting through said attributes to match said alarm condition with a pre-determined alarm condition.

33. The method as claimed in claim 32, wherein said sifting operation enables an alarm message to be terminated if a match with a pre-determined alarm condition is found.

34. The method as claimed in claim 30, wherein said step of applying configuration rules further includes the step of performing a logging operation for automatically logging alarm conditions in a second storage means at or near said first storage means and accessible therefrom.

35. The method as claimed in claim 34, further including the steps of accessing alarm condition stored in said second storage means and generating reports containing said past alarm conditions.

36. A telecommunications network alarm monitoring system comprising:
a service control point comprising:
a transaction server;
a communications server; and
a terminal server to provide access to a plurality of event messages from the transaction server and communications server and to transmit the same over a network link;
a telecommunications network alarm monitoring server linked to the terminal server of the service control point over the network link;
a network alarm monitoring process to map the event messages to an alarm data structure; and
a network link to the telecommunications network alarm monitoring server to enable transmission of messages by the network alarm monitoring server in response to recognized alarm conditions.

37. The telecommunications alarm monitoring system of claim 36 wherein access is enabled to the terminal server is over an Internet Protocol network.

38. The telecommunications alarm monitoring system of claim 36 wherein the link to the telecommunications network alarm monitoring server to enable transmission of messages by the telecommunications network alarm monitoring server in response to recognized alarm conditions comprises an Internet Protocol network.
